(19) United States
(12) Patent Application Publication
(10) Pub. No.: US 2011/0057452 A1
(43) Pub. Date: Mar. 10, 2011

(54) WIND TURBINE HAVING AN AIRFLOW DEFLECTOR

(76) Inventors: Antony Glenn Interlandi, Victoria (AU); Ronald Alan Ellis, Chewton (AU)

(21) Appl. No.: 12/666,707

(22) PCT Filed: Jun. 27, 2008
(86) PCT No.: PCT/AU2008/000951

§ 371 Date: Oct. 1, 2010

(30) Foreign Application Priority Data
Jun. 27, 2007 (AU) 2007903448

(51) Int. Cl. F03D 9/00; F04D 1/00

(52) U.S. Cl. 290/55; 415/182.1

(57) ABSTRACT

A wind turbine (10) comprising: a rotor (12), the axis of rotation extending longitudinally through said rotor (12); a plurality of blades (18) mounted to the rotor (12) to drive the rotor (12) in response to an airflow: and an airflow deflector (30) located for directing airflow through the rotor (12) to increase the efficiency of the turbine (10). The airflow deflector (30) is located inward of the blades (18) which have a fixed pitch relative to the centre of rotation of the rotor (12). Airflow deflector (30) is located around the centre of rotation of rotor (12). The blades (18) also are aerodynamically configured to provide lift due to airflow behavior through the rotor (12) and airflow deflector (30).

### BACKGROUND OF THE INVENTION

1. Field of the Invention

This invention relates to wind turbines.

2. Description of the Relevant Art

Wind power is a recognized energy source from which electricity may be generated without consumption of non-renewable resources. It has the advantages of producing energy in ways that do not create chemical pollution while maintaining costs of energy production at a low level.

However, wind power has tended to need to be harnessed using wind farms having a number of windmills or wind turbines in order to generate sufficient energy and electricity generation capacity. Such windmills are typically horizontal axis windmills having a number of blades which rotate about a generally horizontal axis. These blades operate using drag, the air pressure acting on a surface of the blade imparting energy.

Such wind farms have been criticized as causing other forms of pollution, notably visual and noise pollution. Therefore, such wind farms tend to be located in relatively remote areas or out at sea where these polluting factors may be minimized while producing sufficient electricity to power an electrical grid.

Wind turbines have been employed for generation of power. However, wind turbines of conventional design are mechanically complex, very sensitive to wind speed, susceptible to damage and noisy.

GB Patent Application No. 2275085 discloses a wind turbine with a plurality of vanes or blades tangentially angled about the axis of a drum-like frame. The vanes are arranged inward of the circumference of the housing. The angle of attack on the vanes may be adjusted by a governor, or manually, by means of a mechanism comprising two relatively rotatable coaxial rings. Such an arrangement is mechanically complex.

International Application No. WO 2006/095369 discloses an aeolian turbine with a plurality of blades and a plurality of air deflection means arranged along the perimeter of a rotor. The air deflection means are located radially outward of the blades.

U.S. Pat. No. 4,362,470 discloses a wind turbine with two decks (upper and lower) of non-aerodynamic-in the sense of being non aerofoil-blades that extend from the centre of rotation of a rotor towards the circumference of the rotor. The blades are fixedly connected with the shaft of the turbine for joint rotation therewith. No airflow deflector is provided.

### SUMMARY OF THE INVENTION

It is an object of the present invention to harness wind power through use of wind as a source of energy and electrical generation capacity for domestic, commercial, and industrial sites using wind turbines while avoiding or minimizing one or more of the problems of mechanical complexity, sensitivity to wind speed, susceptibility to damage and noise.

With this object in view, the present invention provides a wind turbine comprising:
a rotor, the axis of rotation extending vertically through said rotor;
a plurality of blades mounted to the rotor to drive the rotor in response to an airflow, the blades having a fixed pitch relative to the centre of rotation of the rotor; and
an airflow deflector located for directing airflow through the rotor to increase efficiency of the turbine, wherein the airflow deflector is located inward of the blades around the centre of rotation of the rotor and the blades are aerodynamically configured to provide lift due to airflow behavior through the rotor and the airflow deflector.

By “aerodynamically configured” is advantageously intended an aerofoil shape that allows the rotatable housing or rotor to harness airflow from both directions over the blade. To this end, each blade is advantageously provided with a skinned surface and an open surface. The skinned surface has less induced drag when headed into the wind in contrast to the open surface which has slightly more drag when headed into the wind. The skinned surface has no torque generating properties when headed down wind whereas the open surface generates significantly more torque when headed down wind. The leading edge of the skinned surface generates significant drag when headed down wind. The open surface leading edge generates insignificant drag when headed down wind.

The blades are configured such that a positive airflow over the leading edge of each blade generates lift and may, additionally, be configured such that a centre of lift is positioned forward of a centre of rotation of the housing. This acts to increase the torque on the rotor created by the lift on the blade and, in turn, leads to an increase in rotational speed and rotor efficiency. Each blade may form a discrete enclosure about a circumference of the preferred circular or cylindrical rotor.

The aspect ratio, or height to diameter ratio, of the rotor is selected to achieve the desired rotational speed and electricity generation capacity under expected wind conditions.

The airflow deflector is conveniently arranged towards, and around, the centre of the rotor and advantageously coaxial with a central vertical axis of the rotor. The position of each of the blades relative to the air deflector induces a venturi effect which increases the effectiveness of a lifting surface incorporated into each blade. The increase in generated lift resulting from the applied venturi improves the rotation speed and torque loading of the rotor, though advantageously requires control over rotation speed as described below.

The air deflector may have a circular or curved surface. The air deflector is highly advantageously cylindrical and may be dimensioned with a diameter substantially less than the diameter of the rotor though sufficient to induce the abovementioned venturi effect.

The size of the airflow deflector is determined by balancing of accelerated airflow, parasitic drag (drag induced by airflow over blades and deflector) and fluid resistance. The position, shape and scale of the air flow deflector is selected to shadow or eclipse a blade in the furthest downwind position. This acts to increase the efficiency of the turbine by reducing the drag which would otherwise be induced by this blade.

To further improve performance, the air flow deflector is scaled to induce an increased airflow between itself and the into-the-wind blade, thus using Bernoulli's principle to further increase the effectiveness of the lifting surface having a centre of lift forward of the centre of rotation.

The aerodynamically configured blades are set at 90 degrees to the sweep of the rotor. Blade angle is set so that angle of attack of the blades does not exceed stall angle during rotation of the rotor. Stalling would cause the wind turbine to lose effectiveness as an electricity generator.

Rotational speed of the rotor may be controlled through use of an aerofoil of selected characteristic such that, when the rotor reaches a predetermined rotational speed, the airflow over the lifting surface separates, inducing significant drag and slowing down the rotational speed. Such delamination of the airflow over the lifting surface causes cavitations between the induced airflow and the lifting surface. The cavitations, caused by a vacuum created between the (delaminated) airflow and the trailing surface of the blade, induce significant drag on the wing. Further, the delaminated airflow strikes the upturned trailing edge at an angle, further increasing drag. This in turn causes a braking effect which limits the rotational speed without employment of complex braking mechanisms.

A stator, forming the static portion of the alternator for generation of electricity, may conveniently be arranged or integrated into the base of the rotatable housing, avoiding the need for a power transfer shaft and minimizing the number of moving components, thus reducing the cost and complexity of the wind turbine.

The wind turbine may conveniently be employed in domestic, commercial and industrial applications without the need for construction of wind farms. The aerodynamic configuration of the blades increases efficiency and reduces noise, even during cavitations. It is anticipated that the maximum noise generated by the turbine in extreme wind conditions will be less than 110 dB or urban noise limitation, and potentially in the order of 30 dB, well below background noise.

### BRIEF DESCRIPTION OF THE DRAWINGS

The wind turbine of the invention may be more fully understood from the following description of a preferred embodiment thereof, made with reference to the accompanying drawings in which:

FIG. 1 is a side perspective of a wind turbine in accordance with one embodiment of the present invention;

FIG. 2 is a cross-sectional elevation of the wind turbine of FIG. 1;

FIG. 3 is a cross-sectional plan view of the wind turbine of FIG. 1; and

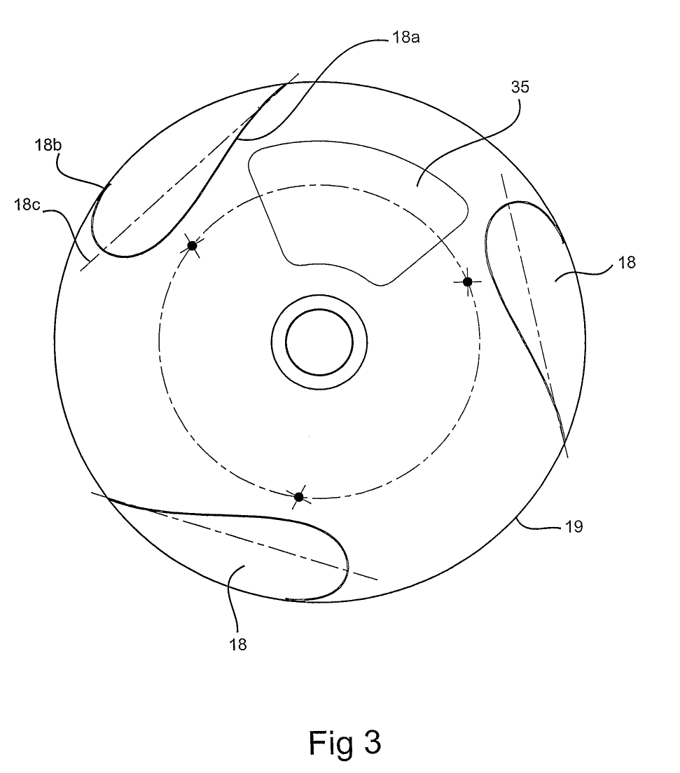

FIG. 4 is a plan of a blade used within the wind turbine of FIG. 1.

FIG. 5 is a top sectional view of the rotor of the wind turbine showing airflow behavior through the rotor in operation.

### DETAILED DESCRIPTION OF THE PREFERRED EMBODIMENTS

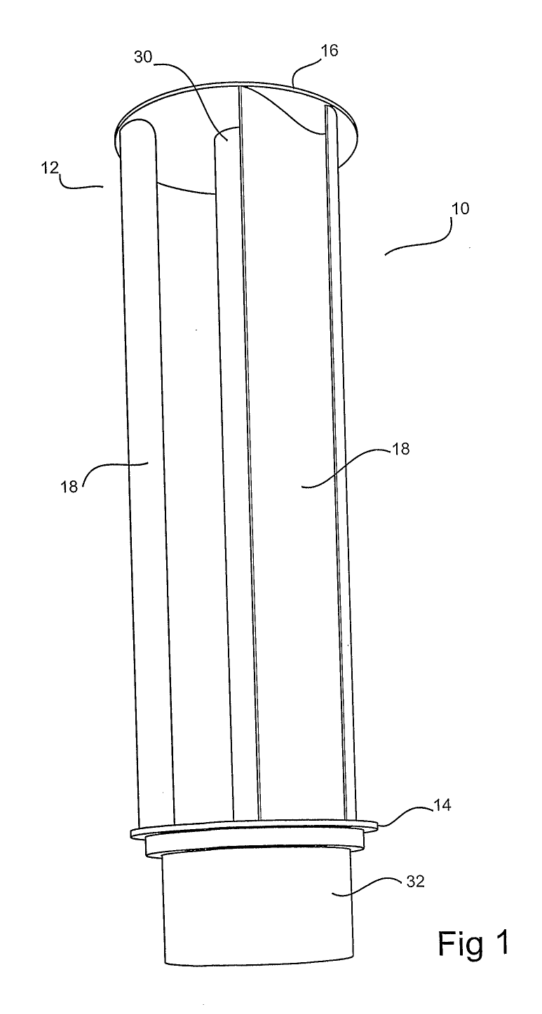

Referring now to FIG. 1, there is shown a wind turbine 10 which includes a rotatable housing or rotor 12 of generally cylindrical shape. The height and diameter (or aspect ratio) of rotor 12 are selected to achieve the desired rotational speed and electricity generation capacity under expected wind conditions at the location of the wind turbine 10.

The rotor 12 is of generally cylindrical construction, having a base 14 and a top plate 16, of generally circular shape, between which extend a number of blades 18 which have a fixed pitch relative to a centre of rotation of the rotor 12. Rotor 12 may have a section 35 machined out to provide mass relief. Rotor 12 has an axis of rotation extending vertically through the centre of rotation of the rotor 12. Such a “vertical axis” is characteristic of the vertical axis turbine.

The rotor 12 is arranged to rotate about the vertical axis extending through airflow deflector 30, the rotor 12 being placed at sufficient height to encounter wind forces. Blades 18 may be welded, or otherwise fixed, to the base 14 and top plate 16 of rotor 12 radially outward from air deflector 30. They are not variable in pitch, allowing a simpler and more efficient construction. Preferably, mounting arrangements for blades 18 may be adopted which allow for replacement of the blades 18 in case of damage. In the embodiment of the drawings, three blades 18 are incorporated within the rotor 12, each being arranged about a centre of the rotor 12. It will be appreciated that the number of blades 18 may be selected by the operator having regard to the desired generation capacity, the expected wind conditions and cost. It is to be noted that blades 18 are not connected either to a power shaft or the air deflector 30.

Airflow deflector 30 is integrated structurally with the base 14 and top plate 16 of rotor 12. It is shaped, sized, and positioned to shadow the blade 18, furthest downwind of it. A cylindrical shape, and curved or circular deflector shape is shown as this has been found the optimum shape to enhance rotational speed and related generating capacity for the turbine. Other shapes such as triangular, hexagonal and teardrop shapes provide less generating capacity as reflected by top rotor speeds attainable at a given wind speed as shown in Table 1 below.

TABLE 1
Deflector Shape and Top Rotor Speed
at Given Wind Speed

| | |
|---|---|
| Teardrop | 120 rpm |
| Triangular | 140 rpm |
| Parabolic | 150 rpm |
| Hexagonal | 160 rpm |
| Circular/Cylindrical | 180 rpm |

Its substantially lesser diameter than the diameter of the rotor 12 may be noted as may its location inward of blades 18. In this way, lift forces acting on blades closer to the wind are optimized, rotation speed (subject to control to be described below) is enhanced and, through operation of the alternator, generation of electricity is enhanced.

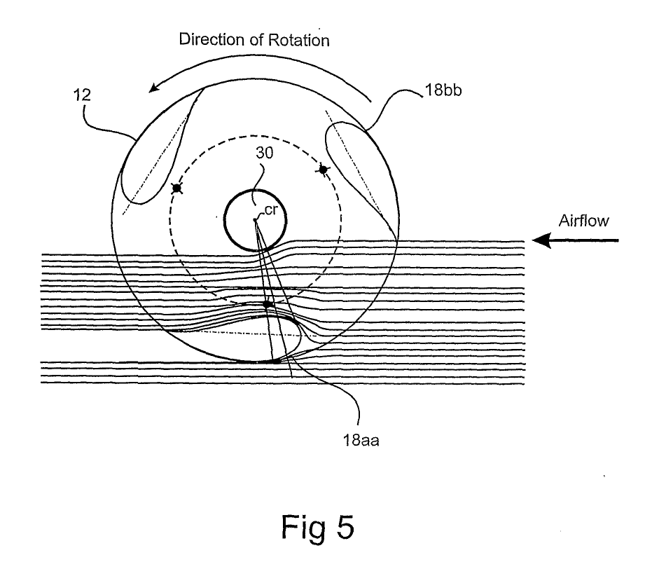

The cylindrical airflow deflector 30 funnels airflow through the centre of the rotor 12 toward the blade 18aa closest to the wind, creating a venturi effect and thus increasing the lift forces acting on that blade and, consequently, the rotational speed of the blade 18aa. The airflow behaviour is conveniently illustrated in FIG. 5. At the same time, drag acting on the open side of blade 18bb also acts to increase rotational speed of that blade 18bb.

It will be observed that the centre of lift is forward of the centre of rotation (cr) of rotor 12, this acting to increase the torque on the rotor 12 created by the lift on blade 18aa also acting to increase the rotational speed of blade 18bb and rotor 12.

Generally, a higher rotational speed is associated with higher electricity generation capacity and is desirable. However, the wind turbine 10 has mechanical limits so some control over rotational speed, as will be described below, is required in operation.

In operation, rotor 12 is left free to rotate about the vertical axis 12a extending through the rotor 12 in response to airflows acting on the blades 18 in windy conditions. Generally, rotor 12 will be mounted with its longitudinal axis being vertically disposed and the wind turbine 10 is therefore of vertical axis type.

The base 14 incorporates a stator 32, or stationary part of an alternator, which allows the generation of electricity, as alternating current, as the rotor 12 rotates as a result of wind induced airflows. The wind turbine 10 is therefore suitable for generation of electricity, generation capacity being related to the rotational speed of rotor 12. This electricity may be provided to a home, a commercial or industrial installation or to a municipal power grid.

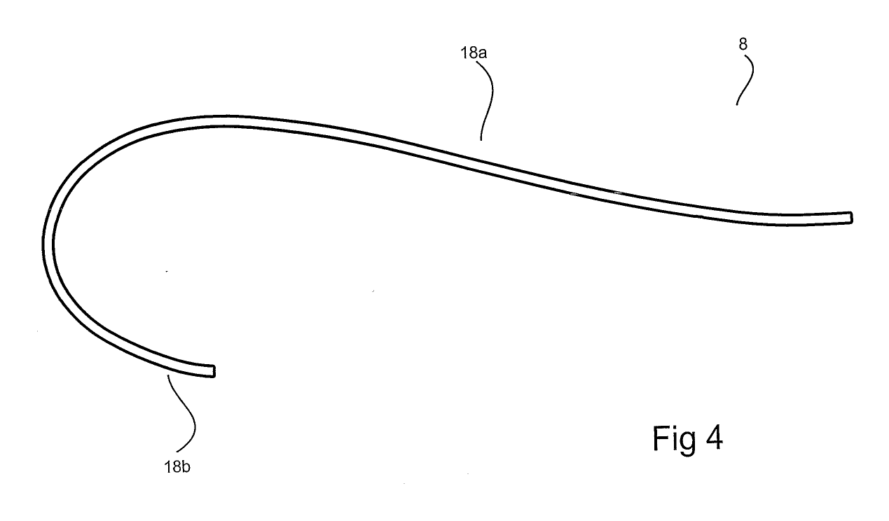

Blades 18 are aerodynamically configured, having an airfoil design. That is, the blades 18 are generally wing shaped and aerodynamic. A detail of a blade 18 is shown in FIG. 4, one surface 18a being skinned and the other surface 18b being open. Chord line 18c is a curved arc reflective of the circumferential arc of the rotor base 14 and top plate 16. This arc was found to be advantageous in the reduction of noise and the increase of effective torque. The curved chord line 18c connects the leading and trailing edges of the airfoil at the ends of the mean camber line of the blade; that is, a line half way between the surfaces 18a and 18b. The employment of such a blade shape allows airflows to be harnessed from both directions over the blade 18, that is, over both surfaces 18a and 18b.

Each blade 18 is positioned at a fixed pitch relative to a line drawn between the centre of rotation and chord line 18c. Specifically, the aerodynamic blades 18 are set at a predetermined angle of incidence, between 10° and 18°, (the angle to be adopted depending on the diameter and subsequent arc of the top and base plates 14 and 16), as calculated from the centre of rotation of rotor 12 to the chord line 18c. It will be seen that no portion of a blade 18 extends beyond a circumference 19 of the rotor 12. Each blade 18 is also spaced equidistantly around the circumference of the rotor 12 to form a discrete enclosure about a portion of the circumference of rotor 12. This equidistant arrangement of the blades 18 provides rotational stability, the ability to self start, and allows airflow over substantially all parts of the blades 18, providing for the application and use of Bernoulli's principle for increasing effectiveness of the turbine 10. The angle of incidence is selected to provide the maximum lift and minimum drag for each blade 18. The use of a fixed pitch removes complexity and unreliability of variable angle or pitch blades that require governors and other mechanical devices to enable adjustment.

The operation of the wind turbine 10 will now be described.

Rotor 12 is caused to rotate through the behaviour of an airflow, such as induced by wind, directed between the blades 18 of the rotor 12. The configuration of blades 18, with skinned and open surfaces 18a and 18b respectively allows the rotor 12 to harness airflow from both directions over each blade 18. In this way, an efficient conversion of wind energy to mechanical rotation of rotor 12 to generation of electricity due to operation of the alternator may be achieved.

Efficiency in operation is increased further through use of the airflow deflector 30 which deflects airflow around the centre of the rotor 12 creating a venturi effect that increases the effectiveness of lifting surfaces of the leading blade 18, that is the blade closest to the wind.

A positive airflow over a leading edge of a blade 18 generates lift, that is, a change in airflow pressure as a result of fluid flow deformation over a curved shape which reduces external pressure, or drag, acting on the blade, rather relatively increasing pressure on the inward side, causing lift, rotation and the generation of electricity through operation of the associated alternator.

More specifically, when a leading blade 18—being that blade closest to the wind—encounters the wind airflow, lift is generated, causing rotation of rotor 12 and movement of that blade 18 into a trailing position. The curvature of the inner surface of the trailing blade directs the now negative airflow into the inside of the leading edge allowing further rotational force to act on the blade 18 without wastage of energy caused by inability to harness airflow pressure continuously as the rotor 12 rotates.

Control over rotational speed of rotor 12 is necessary to avoid electrical and mechanical damage from an overspeed situation. Rotational speed of the rotor 12 may be controlled through implementation of an aerofoil of selected characteristic. Using too thin a blade 18 will result in an inability to self start of the turbine 10 and a requirement to reach higher speeds before useful torque can be generated. Using too thick a blade will result in an inability to reach effective rotation speeds. Using a warped section (Curved chord to reflect arc of circumferential base 14 and top plates 16) allows the blade 18 to minimize noise as it sweeps through the airflow. It also allows for air to delaminate from the surface of the blade 18 once it reaches a predetermined airspeed, such that, when the rotor 12 reaches a predetermined rotational speed, the airflow over the lifting surface separates, inducing drag and slowing down the rotational speed of turbine 10. Such delamination of the airflow over the lifting surface causes cavitations between the induced airflow and the lifting surface. Such cavitations induce a braking effect which limits the rotational speed of the rotor 12, avoiding overspeed, without employment of complex mechanical braking mechanisms.

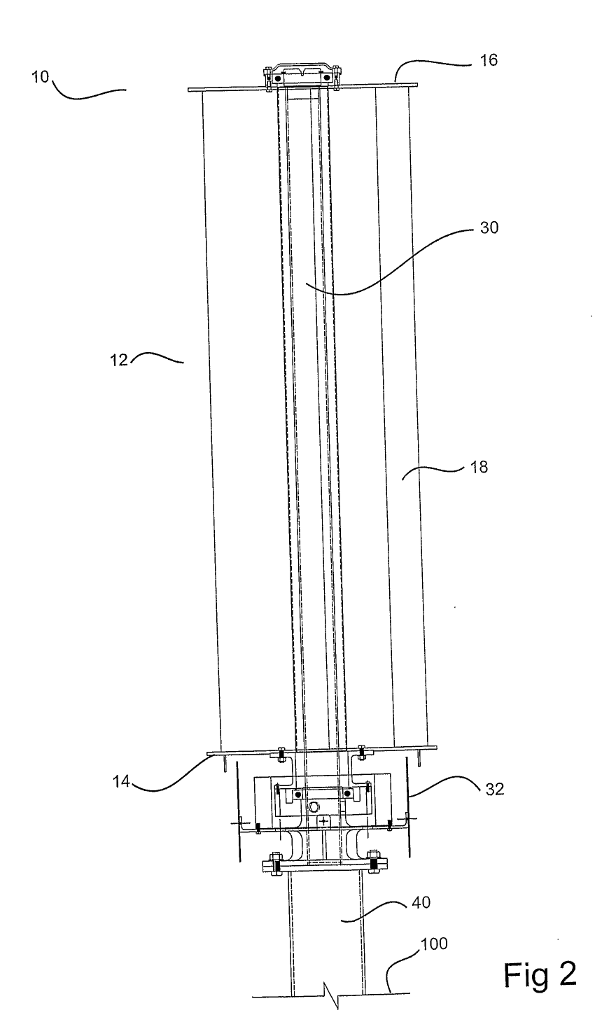

Wind turbine 10 may, as shown in FIG. 2, be employed to provide electrical power to a building (not shown) in a residential area. The mounting pole 40 is selected such that the rotor 12 will be disposed above the roof line 100 of the building to harness airflows caused by the wind. Normally, such airflows would be non-laminar, emphasising the weaknesses of conventional wind turbines in such conditions: namely noise and inefficiency.

However, the design characteristics of the wind turbine 10—as described above—minimise noise (potentially to 30 dB or less noise emission) and increase efficiency, through creation of laminar flow of air over the surfaces of the blades 18, enabling the wind turbine 10 to be usefully employed in a previously non-useful location. Such wind turbines 10 are also less harmful to birdlife since the rotating turbine, in contrast to windmills, presents a solid object to bird vision, which is preventative to accidents.

Modifications and variations to the wind turbine of the present invention will be apparent to skilled readers of this disclosure. Such modifications and variations are within the scope of the present invention.

1. A wind turbine comprising:
(a) a rotor, the axis of rotation extending vertically through said rotor;
(b) a plurality of blades mounted to the rotor to drive the rotor in response to an airflow, the blades having a fixed pitch relative to the centre of rotation of the rotor; and
(c) an airflow deflector located for directing airflow through the rotor to increase efficiency of the turbine;
wherein the airflow deflector is located inward of the blades around the centre of rotation of the rotor and the blades are aerodynamically configured to provide lift due to airflow behavior through the rotor and the airflow deflector.

2. The wind turbine of claim 1 wherein the blades have a skinned surface and an open surface to optimize torque generating properties when headed into the wind and downwind.

3. The wind turbine of claim 1 wherein the blades are configured such that a positive flow over a leading edge of each blade generates lift.

4. The wind turbine of claim 3 wherein the blades are configured such that a center of lift is positioned forward of a center of rotation of the rotor to increase torque on the rotatable housing created by lift of the blades.

5. The wind turbine of claim 1 wherein the height to diameter ratio of the rotor is selected to achieve desired rotational speed and electricity generation capacity under expected wind conditions.

6. (canceled)

7. The wind turbine of claim 1 wherein the size of the airflow deflector is determined by balancing at least one parameter selected from the group consisting of accelerated airflow, parasitic drag and fluid resistance.

8. The wind turbine of claim 7 wherein the position, shape and scale of the airflow deflector is selected to shadow or eclipse a blade in the furthest downwind position.

9. (canceled)

10. The wind turbine of claim 1 wherein the airflow deflector is cylindrical.

11. The wind turbine of claim 1 wherein the blades act to separate airflow over the lifting surface at a predetermined rotational speed of the rotor, airflow separation causing a braking effect to limit the rotational speed of the rotor.

12. The wind turbine of claim 1 wherein the blades form an enclosure about a portion of a circumference of the rotor.

13. The wind turbine of claim 1 wherein a stator is arranged or integrated into the base of the rotor.

14. A power generation unit for a building comprising the wind turbine of claim 1 wherein the wind turbine is arranged on a mounting pole proximate to the building.

15. The power generation unit of claim 14 wherein the maximum noise generated by the wind turbine is less than 110 dB.

16. The power generation unit of claim 15 wherein the maximum noise generated by the wind turbine is less than 30 dB
